(19) United States
(12) Patent Application Publication
(10) Pub. No.: US 2022/0032355 A1
(43) Pub. Date: Feb. 3, 2022

(54) DECORATIVE ARTICLE MANUFACTURING METHOD, AND DECORATIVE ARTICLE

(71) Applicant: TOYODA GOSEI CO., LTD., Kiyosu-shi, Aichi-ken (JP)

(72) Inventors: Yujiro ISHIGAMI, Kiyosu-shi, Aichi-ken (JP); Motoshi OGISU, Kiyosu-shi, Aichi-ken (JP); Kimihiro IIMURA, Kiyosu-shi, Aichi-ken (JP)

(21) Appl. No.: 17/277,439

(22) PCT Filed: Oct. 10, 2019
(86) PCT No.: PCT/JP2019/040026

§ 371 Date: Mar. 18, 2021

(30) Foreign Application Priority Data
Oct. 12, 2018 (JP) 2018-193333

(51) Int. Cl. B21D 22/02; B32B 3/30; B32B 7/12; B32B 15/085

(52) U.S. Cl. CPC B21D 22/022; B32B 3/30; B32B 7/12; B32B 2250/02; B32B 2605/00; B32B 2451/00; B32B 15/085

(57) ABSTRACT

A decorative article includes a base and a decorative portion. The base includes a grained surface formed in a grained manner. The decorative portion includes at least a protective layer, a metal layer, and an adhesive layer. The decorative portion is bonded to at least a part of the grained surface of the base by the adhesive layer.

### CROSS REFERENCE TO RELATED APPLICATION

This application is a U.S. National Stage Application of International Application No. PCT/JP2019/040026, filed Oct. 10, 2019, the contents of which are incorporated herein by reference.

### BACKGROUND

The present disclosure relates to a decorative article manufacturing method used to manufacture a decorative article and relates to a decorative article.

A typical method is used to form a decorative portion on a base through, for example, hot stamping (refer to, for example, Patent Document 1). In hot stamping, for example, a hot stamping foil is heated while being pressurized on a base so that a decorative portion including a metal layer and a protective layer is transferred to the surface of the base by an adhesive layer.

### PRIOR ART DOCUMENTS

### Patent Documents

Patent Document 1: Japanese Laid-Open Patent Publication No. 62-282969

### SUMMARY

For such a type of decorative article, there is a need to express a wide variety of decoration. However, the method of Patent Document 1 allows for the manufacturing of only a decorative article in which decoration is made uniformly.

It is an objective of the present disclosure is to provide a decorative article manufacturing method and a decorative article capable of ensuring high ornamentality.

A decorative article manufacturing method that solves the above-described problem is a decorative article manufacturing method for manufacturing a decorative article by bonding a decorative portion to a base by an adhesive layer, the decorative portion including at least a protective layer, a metal layer, and the adhesive layer. The decorative article manufacturing method includes a step that prepares the base, which includes a grained surface formed in a grained manner, and a heat transfer laminate in which the decorative portion and a shape retainer are laminated, the shape retainer retaining a shape of the decorative portion, a step that sets the heat transfer laminate on at least a part of the grained surface of the base, a step that bonds the decorative portion to the base by bonding the adhesive layer to a surface of the base through heat treatment, the adhesive layer being a lowermost layer of the heat transfer laminate, and a step that separates the shape retainer from the decorative portion with the decorative portion bonded to the base left.

In the above-described structure, the decorative article can be manufactured with the decorative portion and the grained surface arranged on the base. This allows the decorative article to be manufactured with high ornamentality.

In the above-described decorative article manufacturing method, it is preferred that a grain depth of the base be set in a range from 5 to 15 μm inclusive.

In the above-described structure, an optimal grain depth can be set to allow the decorative portion to be firmly bonded to the base.

In the above-described decorative article manufacturing method, it is preferred that the step that bonds the decorative portion to the base perform hot stamping to bond, through the heat treatment by an apparatus, the decorative portion to the base by pressing the apparatus against the heat transfer laminate set on the base.

The above-described structure allows the decorative portion to be bonded to the base using a simple process with hot stamping.

In the above-described decorative article manufacturing method, it is preferred that the hot stamping include pre-stamping and main stamping, the pre-stamping include setting a pre-stamping foil on at least a part of the surface of the base on which the decorative portion is arranged and processing the surface of the base by pressing the apparatus against the pre-stamping foil and performing heat treatment, and the main stamping include setting the heat transfer laminate on the base including the surface processed by the pre-stamping and bonding the decorative portion to the base by pressing the apparatus against the heat transfer laminate and performing heat treatment.

In the above-described structure, the decorative portion that looks different from the decorative portion arranged on the surface of the base formed in a grained manner can be formed on the base. This is more advantageous to ensure that the decorative article is highly ornamental.

In the above-described decorative article manufacturing method, it is preferred that the grain be a pinseal-pattern grain.

The above-described structure allows the decorative article to be manufactured with high ornamentality. Specifically, the texture of the pinseal-pattern grain makes the decorative article have a varied look with the decorative portion partially arranged on the decorative article.

In the above-described decorative article manufacturing method, it is preferred that the decorative article be an exterior part for a vehicle.

In the above-described structure, an exterior part for a vehicle can be manufactured with high ornamentality.

A decorative article that solves the above-described problem includes a base including a grained surface formed in a grained manner and includes a decorative portion including at least a protective layer, a metal layer, and an adhesive layer, the decorative portion being bonded to at least a part of the grained surface of the base by the adhesive layer.

In the present disclosure, high ornamentality is ensured.

### BRIEF DESCRIPTION OF THE DRAWINGS

FIG. 1 is a cross-sectional view showing a decorative article according to an embodiment.

FIG. 2 is a partial perspective view showing the decorative article.

FIG. 3 is a schematic diagram showing a processing machine.

FIGS. 4A to 4C are diagrams illustrating the steps of the decorative article manufacturing method.

FIGS. 5A and 5B are diagrams illustrating the steps of the decorative article manufacturing method according to a modification.

### DETAILED DESCRIPTION OF THE PREFERRED EMBODIMENTS

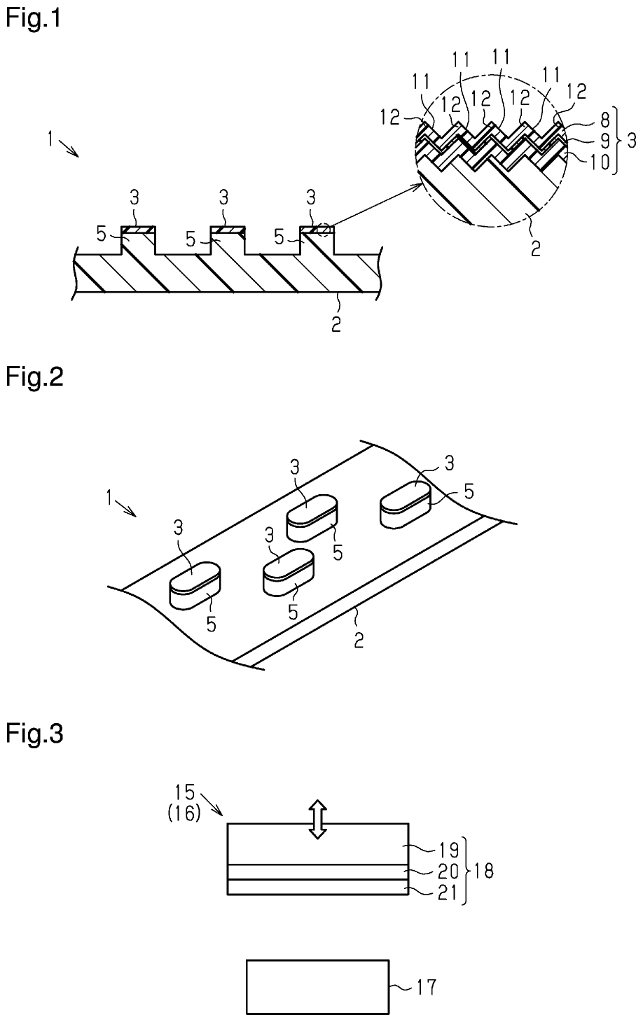

decorative article manufacturing method and a decorative article according to an embodiment will now be described with reference to FIGS. 1 to 4C.

A decorative article 1 shown in FIGS. 1 and 2 is a radiator grille, which is an exterior part for a vehicle. The decorative article 1 includes a base 2 and decorative portions 3, which are arranged on at least part of the surface of the base 2. The base 2 is made of, for example, resin such as polypropylene (PP). The base 2 includes protrusions 5, which are arranged in a partial manner (in a spotty manner). It is preferred that the protrusions 5 have a substantially oval shape in a plan view. The decorative portions 3 are respectively arranged on the protrusions 5 to function such that the base 2 has a varied look and is highly ornamental.

As shown in FIG. 1, the surface of the base 2, which includes the protrusions 5, is formed with a predetermined crease pattern (i.e., formed in a grained manner). It is preferred that the grain (grained surface) be, for example, a pinseal-pattern grain, which has a rough surface. On the surface of the grained base 2, each decorative portion 3 is formed on the entire surface of the corresponding protrusion 5.

The decorative portion 3 includes a protective layer 8, which protects the surface of the decorative portion 3, a metal layer 9, which makes the decorative portion 3 ornamental, and an adhesive layer 10, which bonds the decorative portion 3 to the base 2. The protective layer 8 protects the metal layer 9, which is formed like a thin film. The protective layer 8 is made of, for example, resin (such as urethane resin). The protective layer 8 includes a transparent layer (clear layer) such that the metal layer 9, which is located at the rear of the protective layer 8, is visible. The metal layer 9 is formed through, for example, wet plating or dry painting. The adhesive layer 10 is made of, for example, material that is easily adapted to the base 2 when processing is performed to bond the decorative portion 3 to the base 2. Examples of the material include acrylic-based resin, chlorinated polypropylene-based resin, vinyl chloride acetate-based resin, and polyester-based resin.

The surface of each decorative portion 3 is shaped to have recesses and projections in conformance with the shape of the grained surface of the base 2. Thus, the entire front surface of the decorative portion 3 includes recesses 11 and projections 12.

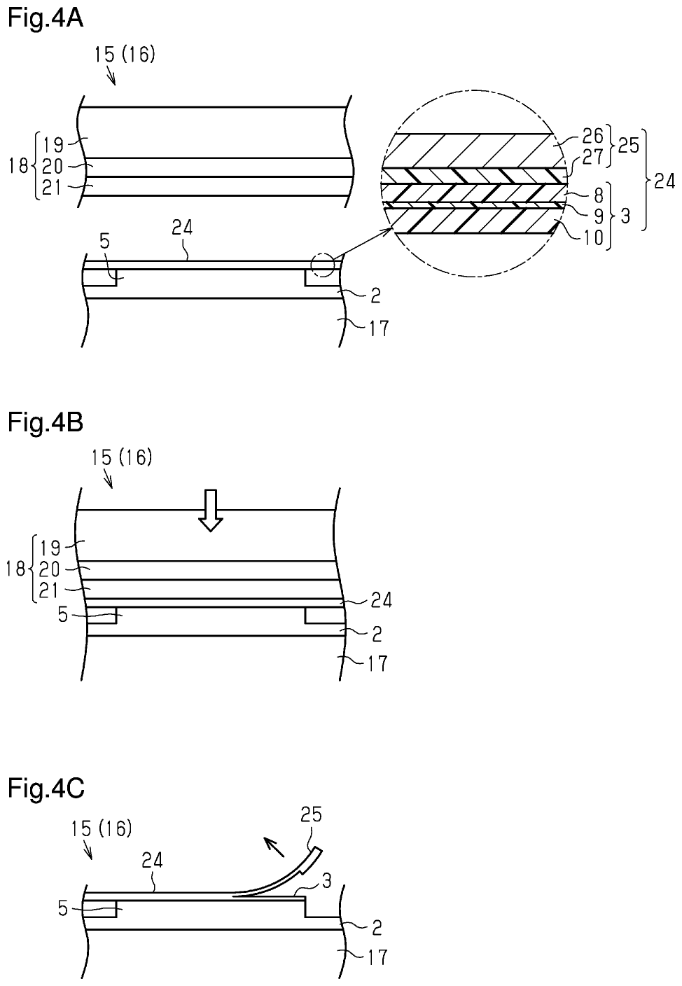

The procedure for the decorative article manufacturing method in the present embodiment (the method for manufacturing the decorative article 1, which is a radiator grille) will now be described with reference to FIGS. 3 and 4C.

As shown in FIG. 3, the processing machine 15 is used to bond the decorative portions 3 to the base 2. More specifically, a hot stamping machine 16, which is used to perform bonding through heat transfer, is used as the processing machine 15. The hot stamping machine 16 includes a table 17, on which a workpiece is set, and an apparatus 18, which is movable up and down relative to the table 17. The apparatus 18 presses, from above, the workpiece set on the table 17 to perform heat treatment, thereby bonding the decorative portions 3 to the base 2. The apparatus 18 of the present embodiment includes a pressurizing machine 19, which applies a constant pressure to the workpiece, a heat plate 20, which applies heat to the workpiece, and a rubber plate 21, on which the workpiece is pressed. For example, it is preferred that the rubber plate 21 have a hardness of 70° and have a thickness of 2 mm.

To manufacture the decorative article 1, the base 2, which includes a grained surface formed in a grained manner, and a heat transfer laminate 24 are first prepared. In the heat transfer laminate 24, the decorative portion 3 and a shape retainer 25, which retains the shape of the decorative portion 3, are laminated. More specifically, the heat transfer laminate 24 includes, for example, the shape retainer 25, the protective layer 8, the metal layer 9, and the adhesive layer 10 in this order from the upper side. The shape retainer 25 is used to retain the shapes of the elements of the decorative portion 3, including the protective layer 8, such that these shapes remain unchanged when hot stamping is performed for the heat transfer laminate 24 on the base 2. It is preferred that the shape retainer 25 include a film 26 and a separating layer 27.

The film 26 is made of, for example, polyethylene terephthalate (PET). The separating layer 27 is formed by applying thermoplastic resins including, for example, melamine resin onto the film 26 through gravure coating. The protective layer 8 is formed by applying, to the surface of the separating layer 27 through gravure coating, mixed resin produced by mixing a predetermined acrylic copolymer and curing agent. The metal layer 9 is formed by, for example, evaporating chromium or the like on the surface of the protective layer 8 through physical vapor deposition. The metal layer 9 includes, for example, a chromium thin film having a thickness of approximately 30 nm. The adhesive layer 10 is formed by, for example, applying material including chlorinated polypropylene to the surface of the metal layer 9 through gravure coating.

As shown in FIG. 4A, to bond the decorative portions 3 to the base 2, the heat transfer laminate 24 is set on the surface (grained surface) of the base 2 (heat transfer laminate setting step). In the present embodiment, the workpiece in which the heat transfer laminate 24 and the base 2 are overlapped with each other is set on the table 17 of the processing machine 15.

As shown in FIG. 4B, after the workpiece is set on the table 17, the heat transfer laminate 24 is bonded to the surface of the base 2 through heat treatment (heat transfer laminate bonding step). In the present embodiment, the apparatus 18 of the processing machine 15 is pressed against the heat transfer laminate 24 to bond the adhesive layer 10 (lowermost layer of the heat transfer laminate 24) to the surface of the base 2 through heat treatment. In this heat transfer, the heat of the processing machine 15 is transferred through the protective layer 8 and the metal layer 9 to the adhesive layer 10 so that the transferred heat bonds the adhesive layer 10 to the base 2. It is preferred that the heat transfer be performed in a condition in which, for example, the surface temperature of the rubber plate 21 is 153° C., the decorative surface pressure is 4 Mpa, and the stamping time is 2 sec.

As shown in FIG. 4C, after the heat transfer laminate 24 is bonded to the base 2, the shape retainer 25 is separated from the decorative portion 3 with the decorative portion 3 bonded to the base 2 left (shape retainer separating step). More specifically, after the heat transfer laminate 24 is bonded to the base 2, the apparatus 18 is lifted to then cool the decorative portion 3 and lift the shape retainer 25. Thus, the shape retainer 25 and the part of the decorative portion 3 that is not bonded to the base 2 are separated from the bonded portion. As a result, only the decorative portion 3 located on the surface of the base 2 is left on the base 2. Accordingly, the decorative article 1 with the decorative portion 3 transferred to the base 2 is obtained.

The operation and advantages of the decorative article manufacturing method and the decorative article 1 of the present embodiment will now be described with reference to Table 1.

Table 1 shows the result of an initial adhesion test for the decorative portion 3 of the manufactured decorative article 1 (radiator grille in the present embodiment). In this test, multiple decorative articles 1 each having a grain pattern A, multiple decorative articles 1 each having a grain pattern B, and multiple decorative articles 1 each having a grain pattern C were used. With the grain depths differentiated between these decorative articles 1, the initial adhesion test was conducted to check whether water-resistant adhesion performance was achieved. Further, the grain patterns A to C are different in, for example, the intervals, patterns, and sizes of the grains.

TABLE 1

| | | Grain Pattern | | |
|---|---|---|---|---|
| | | Pattern A | Pattern B | Pattern C |
| Grain Depth | 10 | ○ | | ○ |
| [μm] | 15 | ○ | ○ | ○ |
| | 20 | × | | × |
| | 25 | | × | |
| | 30 | | | × |
| | 35 | | × | |

In Table 1, the character “∘” indicates that the standard of the water-resistant adhesion performance was satisfied, and the character “x” indicates that the standard of the water-resistant adhesion performance was not satisfied. As is obvious from Table 1, when the grain depth is less than or equal to 15 μm, the standard of the water-resistant adhesion performance was satisfied in all of the grain patterns A to C. This indicates that the grain of the surface of the base 2 is preferably shaped to have a grain depth of less than or equal to 15 μm.

Thus, in the present embodiment, the decorative portions 3, which produce ornamentality, are provided on at least the parts (protrusions 5) of the surface (grained surface) of the base 2 formed in a grained manner. Accordingly, the decorative article 1 (radiator grille in the present embodiment) can be manufactured with the decorative portions 3 and the grained surface arranged on the base 2. This allows the decorative article 1 (radiator grille in the present embodiment) to be manufactured with high ornamentality. In this manner, the decorative article 1 (radiator grille in the present embodiment) achieves a new design decorated in a partial manner with the application of the grained surface. Additionally, the decorative article 1 provides a new tactile sense.

The grain depth of the base 2 is set in a range from 5 to 15 μm inclusive. Thus, an optimal grain depth can be set to allow the decorative portions 3 to be firmly bonded to the base 2. This ensures the product durability of the decorative article 1.

In the step that bonds the decorative portions 3 to the base 2, hot stamping is performed to bond, through the heat treatment by the apparatus 18, the decorative portions 3 to the base 2 by pressing the apparatus 18 against the heat transfer laminate 24 set on the base 2. This allows the decorative portions 3 to be bonded to the base 2 using a simple process with hot stamping.

The grain of the base 2 is a pinseal-pattern grain. This allows the decorative article 1 (radiator grille in the present embodiment) to be manufactured with high ornamentality. Specifically, the texture of the pinseal-pattern grain makes the decorative article 1 have a varied look with the decorative portions 3 partially arranged on the decorative article 1.

The present embodiment may be modified as follows. The present embodiment and the following modifications can be combined as long as they remain technically consistent with each other.

Only a part of the base 2 may have a grain shape such that the grained surface includes the decorative portions 3. This allows for a complex design created by the decorative portions 3 and by the presence or absence of grains in the base 2. In this case, the decorative portions 3 may be formed at the part of the base 2 that does not include the grained surface. This ensures higher ornamentality.

The colors of the base 2 and the decorative portions 3 may differ from each other. For example, the base 2 is colored white and the decorative portions 3 are colored black. This allows the decorative article 1 to have a wide variety of colors.

In the decorative portion 3, a top layer may be arranged between the metal layer 9 and the adhesive layer 10 to limit the formation of cracks in the metal layer 9.

The protective layer 8, the adhesive layer 10, and the separating layer 27 do not have to be formed through gravure coating. Instead, these layers may be formed through various known coating methods, such as reverse coating or die coating.

Heat treatment (heat transfer) is not limited to hot stamping. Instead, another process such as an in-mold process may be employed.

The heat transfer laminate 24 does not have to include a group of the types of layers as described above. Instead, the heat transfer laminate 24 simply needs to include a layer that allows the decorative portions 3 to be transferred to the base 2.

The shape retainer 25 does not have to include the film 26 and the separating layer 27. Instead, the shape retainer 25 may include other members.

The thicknesses of the base 2 and the heat transfer laminate 24 may be set to necessary values.

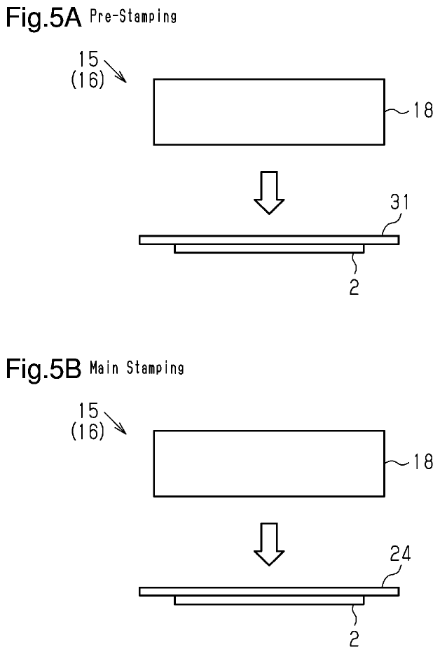

As shown in FIGS. 5A and 5B, hot stamping may be a manufacturing method including two processes, namely, pre-stamping and main stamping. As shown in FIG. 5A, the pre-stamping includes setting a pre-stamping foil 31 on at least a part of the surface of the base 2 on which the decorative portions 3 are arranged (i.e., the protrusions 5) and processing the surface of the base 2 by pressing the apparatus 18 against the pre-stamping foil 31 and performing heat treatment. The pre-stamping foil 31 is made of, for example, polyethylene terephthalate (PET). The pre-stamping removes and flattens the grains of the part of the surface of the base 2 processed by the pre-stamping foil 31, i.e., the grains of a decorated surface. In the pre-stamping, the apparatus 18 of the processing machine 15 does not have to be made of rubber material but may be made of aluminum.

As shown in FIG. 5B, the main stamping, which follows the pre-stamping, includes setting the heat transfer laminate 24 on the base 2 with the flattened grains of the decorated surface and bonding the decorative portions 3 to the base 2 by pressing the apparatus 18 against the heat transfer laminate 24 and performing heat treatment. This allows the decorative portions 3 to be arranged on the flattened surface, which does not include projections or recesses, in the surface of the base 2. Thus, the decorative portions 3 are highly ornamental. In the main-stamping, the apparatus 18 of the processing machine 15 does not have to be made of rubber material but may be made of aluminum.

The decorative portions 3 in this case that look different from the decorative portions 3 arranged on the surface (grained surface) of the base 2 formed in a grained manner can be formed on the base 2. This is more advantageous to ensure that the decorative article 1 is highly ornamental.

The shape of the grain is not limited to a pinseal-pattern grain. Instead, the shape of the grain may be changed to, for example, scale pattern, wood-graining pattern, stone pattern, sand pattern, fabric pattern, or geometric pattern.

The grain depth may have a value outside of the range from 5 to 15 μm inclusive.

The decorative portion 3 simply needs to include at least the protective layer 8, the metal layer 9, and the adhesive layer 10.

It is preferred that the elastic moduli of the protective layer 8 and the metal layer 9 be set to, for example, a combination of values that prevent the metal layer 9 from being cracked.

The shape of the base 2 does not need to have the protrusions 5 in a spotty manner. Instead, the base 2 may be, for example, merely flat.

The base 2 may have a flat shape such that the decorative portions 3 are arranged on the flat surface in a spotty manner.

The decorative portions 3 do not have to be formed on the base 2 in a partial manner. Instead, the decorative portion 3 may be formed on the entire surface of the base 2.

The resin material is not limited to PP. Instead, other materials may be used.

The base 2 does not have to be made of resin. Instead, for example, the base 2 may be made of metal or wood.

The decorative article 1 is not limited to a radiator grille and may be a different exterior part for a vehicle. Additionally, the decorative article 1 does not have to be used for a vehicle and may be used for other purposes.

1. A decorative article manufacturing method for manufacturing a decorative article by bonding a decorative portion to a base by an adhesive layer, the decorative portion including at least a protective layer, a metal layer, and the adhesive layer, the decorative article manufacturing method comprising:
preparing the base, which includes a grained surface formed in a grained manner, and a heat transfer laminate in which the decorative portion and a shape retainer are laminated, the shape retainer retaining a shape of the decorative portion;
setting the heat transfer laminate on at least a part of the grained surface of the base;
bonding the decorative portion to the base by bonding the adhesive layer to a surface of the base through heat treatment, the adhesive layer being a lowermost layer of the heat transfer laminate; and
separating the shape retainer from the decorative portion with the decorative portion bonded to the base left.

2. The decorative article manufacturing method according to claim 1, wherein a grain depth of the base is set in a range from 5 to 15 μm inclusive.

3. The decorative article manufacturing method according to claim 1, wherein the bonding the decorative portion to the base performs hot stamping to bond, through the heat treatment by an apparatus, the decorative portion to the base by pressing the apparatus against the heat transfer laminate set on the base.

4. The decorative article manufacturing method according to claim 3, wherein
the hot stamping includes pre-stamping and main stamping,
the pre-stamping includes setting a pre-stamping foil on at least a part of the surface of the base on which the decorative portion is arranged and processing the surface of the base by pressing the apparatus against the pre-stamping foil and performing heat treatment, and
the main stamping includes setting the heat transfer laminate on the base including the surface processed by the pre-stamping and bonding the decorative portion to the base by pressing the apparatus against the heat transfer laminate and performing heat treatment.

5. The decorative article manufacturing method according to claim 1, wherein the grain is a pinseal-pattern grain.

6. The decorative article manufacturing method according to claim 1, wherein the decorative article is an exterior part for a vehicle.

7. A decorative article, comprising:
a base including a grained surface formed in a grained manner; and
a decorative portion including at least a protective layer, a metal layer, and an adhesive layer, the decorative portion being bonded to at least a part of the grained surface of the base by the adhesive layer.
